(19) United States
(12) Patent Application Publication
(10) Pub. No.: US 2010/0241290 A1
(43) Pub. Date: Sep. 23, 2010

(54) Process And Apparatus For Autonomous Control Of A Motor Vehicle

(76) Inventors: Dennis W. Doane, Cincinnati, OH (US); John B. Wilker, SR., St. Leon, IN (US)

Correspondence Address: CALFEE HALTER & GRISWOLD, LLP, 800 SUPERIOR AVENUE, SUITE 1400, CLEVELAND, OH, 44114, US

(21) Appl. No.: 12/554,826

(22) Filed: Sep. 4, 2009

Related U.S. Application Data
(63) Continuation-in-part of application No. 11/846,104, filed on Aug. 28, 2007, now abandoned.
(60) Provisional application No. 60/840,614, filed on Aug. 28, 2006.

(51) Int. Cl. G06F 17/00

(52) U.S. Cl. 701/2

(57) ABSTRACT

Autonomous control of steering, speed, forward and reverse movement of a motor vehicle is provided by transmitting a signal from a transmitter carried by an ambulatory user, receiving the signal with three signal-receiving antennae on the motor vehicle, generating first, second and third sub-signals with a three-channel receiver connected to the three antennae, generating sum and difference outputs with the first and second sub-signals, affecting the steering with the difference output, affecting the speed, forward and reverse control with the sum output, generating a distance-to-user output from the third sub-signal, and limiting the proximity of the motor vehicle to the user with the distance-to-user output.

### CROSS TO REFERENCE TO RELATED APPLICATION

This is a Continuation-In-Part application based upon U.S. patent application Ser. No. 11/846,104 filed Aug. 28, 2007.

### BACKGROUND OF THE INVENTION

1. Field of the Invention

The present invention relates to a method and apparatus for autonomous control of a motorized vehicle, such as an equipment caddy or cart, and more specifically to a method and apparatus by which the vehicle follows an ambulatory user at a selected distance.

2. Related Art

The weight and structure of a typical golf club bag can be quite cumbersome when carried or pulled over the terrain of a golf course. While many golfers have the desire to walk, carrying a golf bag can be too strenuous. Additionally, it often prohibits a player from maintaining the required speed of play. As a result, the ability to maintain the optimal concentration and focus associated with walking the course must be sacrificed to some degree. For years, manufacturers of golfing equipment transportation devices have sought to overcome this “handicap”. The electronic remote control golf caddy has steadily increased in availability since its introduction and currently appears to dominate the field of possible solutions. Of the many known variations however, none is without limitation to the realization of true freedom for a golfer to devote all of his or her energy to the game rather than the equipment. Relevant prior art includes: U.S. Pat. No. 3,720,281 to Frownfelter; U.S. Pat. No. 3,742,507 to Pirre; U.S. Pat. No. 3,812,929 to Farque; U.S. Pat. No. 3,976,151 to Farque; U.S. Pat. No. 4,023,178 to Suyama; U.S. Pat. No. 4,109,186 to Farque; U.S. Pat. No. 4,844,493 to Kramer; U.S. Pat. No. 5,350,982 to Seib; U.S. Pat. No. 5,517,098 Dong; U.S. Pat. No. 5,711,388 to Davies et al.; U.S. Pat. No. 6,142,251 to Bail; U.S. Pat. No. 6,327,219 to Zhang et al.; U.S. Pat. No. 6,404,159 to Cavallini; and U.S. Pat. No. 6,834,220 to Bail. Other relevant publications are: Powakaddy International Limited, www.powakaddy.com, © 2006; KaddyKarts, Inc., www.kaddykarts.com, © 2006; High Degree Machinery and Electronic Co., Ltd., www.golftrolley.cn, ©2006; SpaCom International LLC, www.batcaddy.com, © 2006; and CaddyBug usa, www.caddybug-usa.com, © 2005

### SUMMARY OF THE INVENTION

In an exemplary form, the apparatus and process for autonomous control of an equipment caddy comprises a portable transmitter, three antennas mounted on the caddy, a 3-channel receiver connected to the antennas, a circuit controller connected to the receiver, at least one electric motor connected to the circuit controller, a battery connected to the electric motor and a power module connected to the battery.

### BRIEF DESCRIPTION OF THE DRAWINGS

FIG. 1 is a block diagram of an exemplary embodiment of the present apparatus;

FIG. 2 is a process flow chart of the embodiment of FIG. 1;

FIG. 3 is a schematic front view of a transmitter according to the exemplary embodiment;

FIG. 4 is a schematic top view of the transmitter of FIG. 3;

FIG. 5 is a flow diagram of exemplary means for indicating the operational status of the transmitter;

FIG. 6 is a perspective view of a caddy equipped with the present apparatus;

FIG. 7 is a schematic view of an exemplary circuit controller for the present apparatus;

FIG. 8 is a schematic view of an exemplary left channel receiver in the controller of FIG. 7;

FIG. 9 is a schematic view of an exemplary middle channel receiver in the subject controller;

FIG. 10 is a schematic view of an exemplary right channel receiver in the controller;

FIG. 10 is a schematic view of an exemplary signal processor in the controller; and

FIG. 11 is a schematic view of an exemplary sum/difference amplifier in the controller.

### DETAILED DESCRIPTION OF AN EXEMPLARY EMBODIMENT OF THE INVENTION

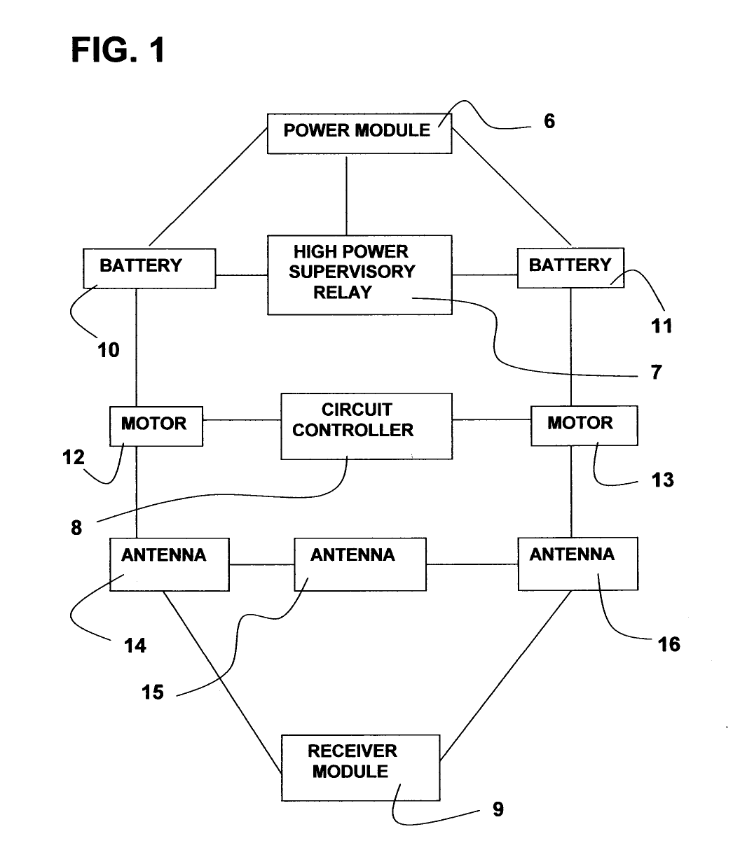

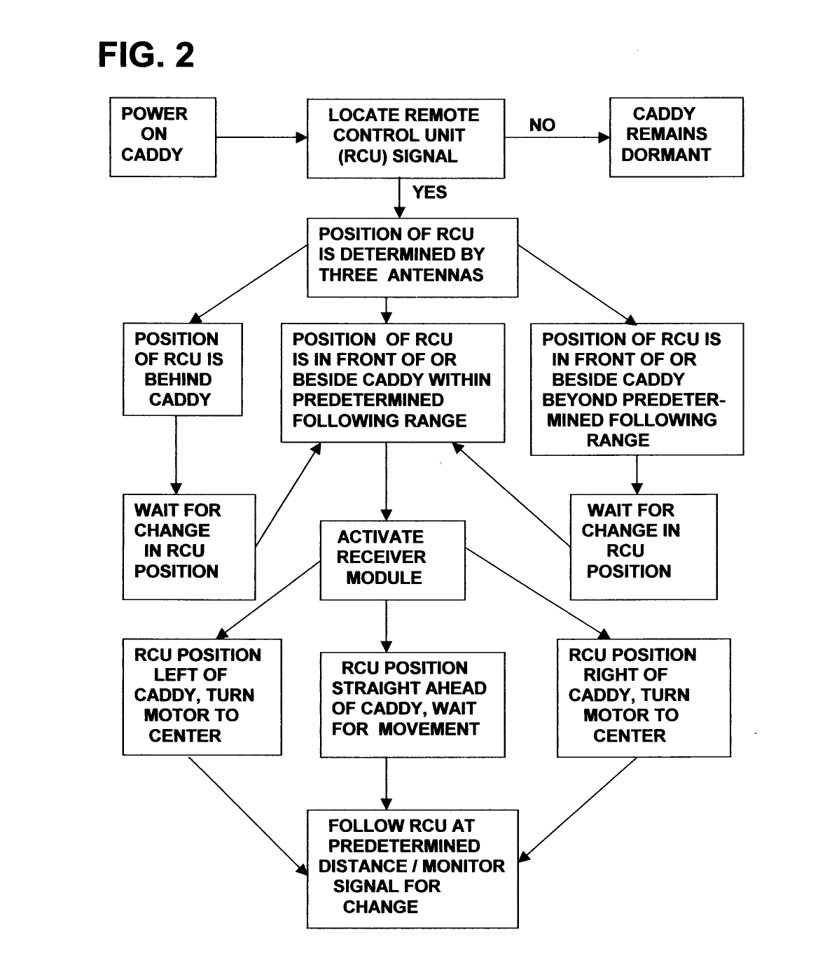

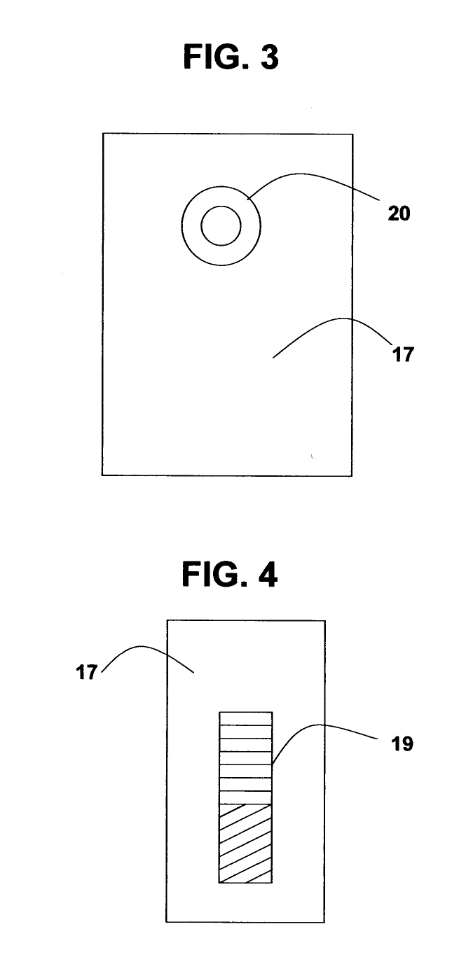

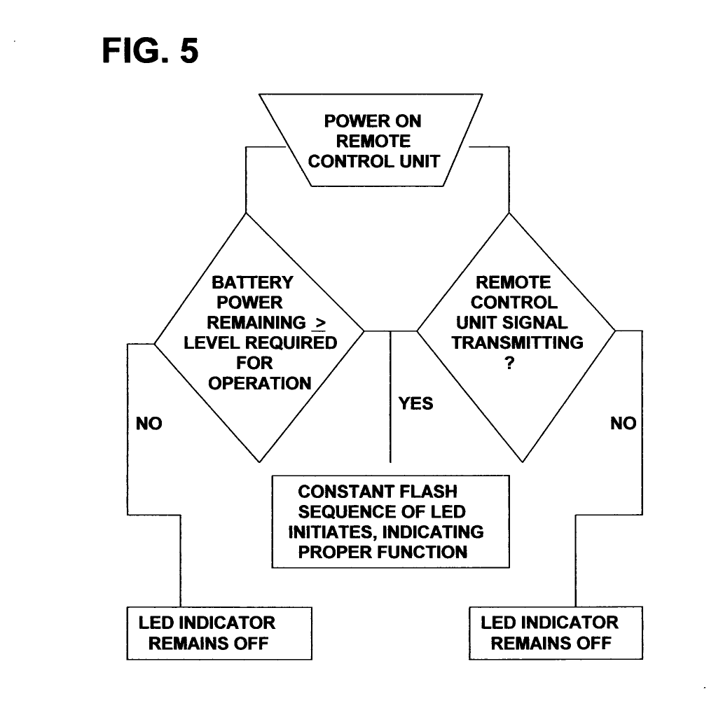

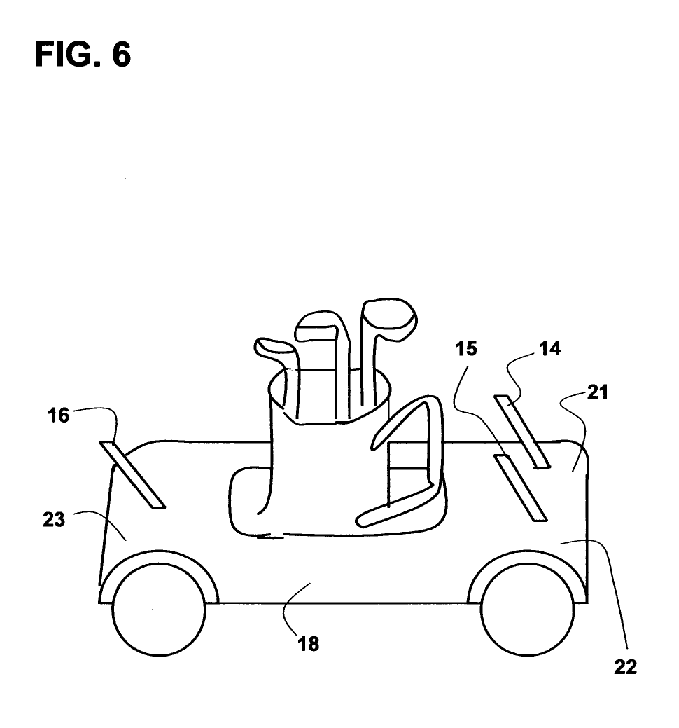

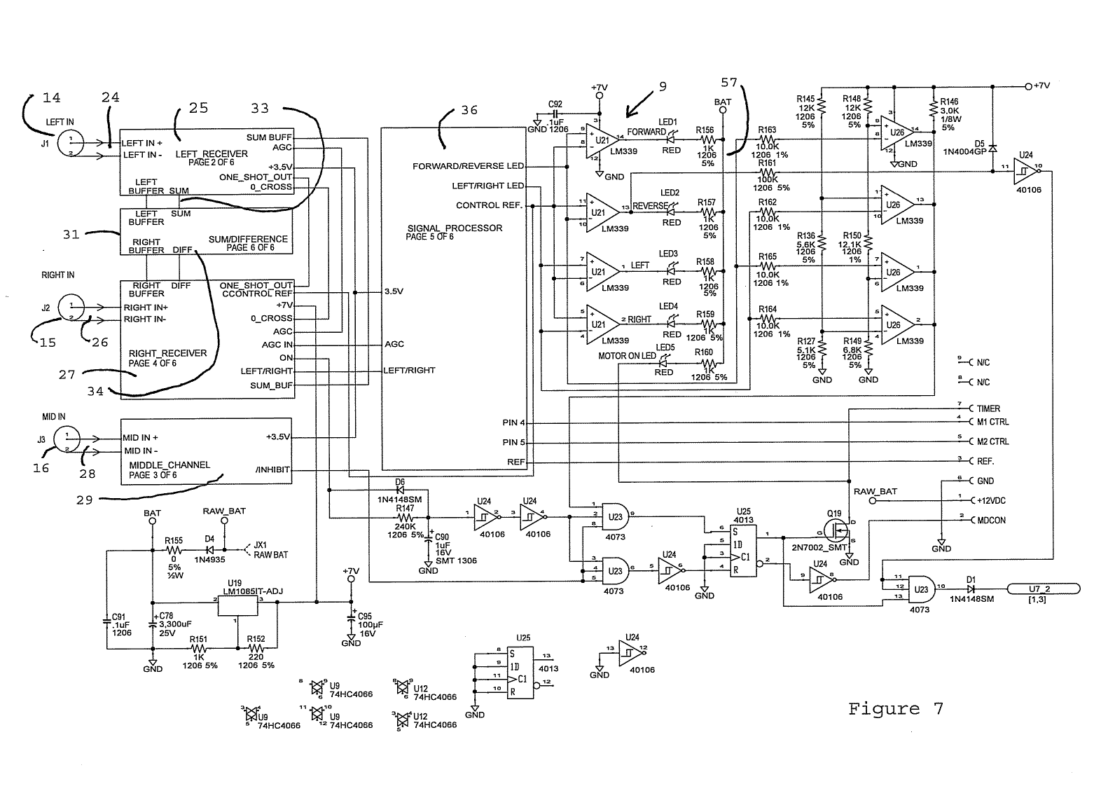

As illustrated in FIGS. 1 and 3, the apparatus, generally designated 10, for autonomous control of a motor vehicle may comprise a power module 6, a high power supervisory relay 7, a circuit controller 8, a three-channel receiver 9, first and second batteries 10, 11, first and second motors 12, 13, first, second and third antennas 14, 15 and 16, and a portable transmitter 17. As illustrated in FIG. 6, the motor vehicle may be a golf equipment cart 18.

The user-carried transmitter 17 illustrated in FIG. 3 may be an intentional radiator of low power, low frequency, continuous wave radio frequency energy. The emitted signal is in the long wavelength spectrum, located below the AM radio broadcast band and designated for directional radio systems. Four different channel frequencies may be available to allow multiple carts to be used in the same group of golfers. For example, channel 1 may be 230 kHz, channel 2 may be 300 kHz and so on. The transmitter 17 may be powered by a common 9V transistor radio battery. An on/off switch 19 may be provided, as well as a flashing LED indicator 20 to indicate the transmission status of the unit 17. In addition, the indicator 20 may change color to indicate battery condition, such as green to indicate a charged battery, yellow to indicate that battery replacement or recharging is needed, and red to indicate that the electrical charge is too low for the transmitter 17 to function correctly. The output of the transmitter 17 may be regulated to remain constant as the battery is discharged; otherwise, the cart 18 would follow the user at a shorter distance as the battery voltage drops. When the battery voltage drops below the point were the proper output can be sustained, the transmitter 17 is tuned off automatically, and the indicator 20 will flash red to prevent anomalous operation due to a weak battery.

The antennae 14-16 (FIGS. 1,6) may be loop stick ferrite core coils tuned to the desired channel frequency with a low impedance secondary winding output. As illustrated in FIG. 6, the first antenna 14 may be located on the left front 21, the second antenna 15 on the right front 22, and the third antenna 16 on the rear center 23 of the equipment cart 18.

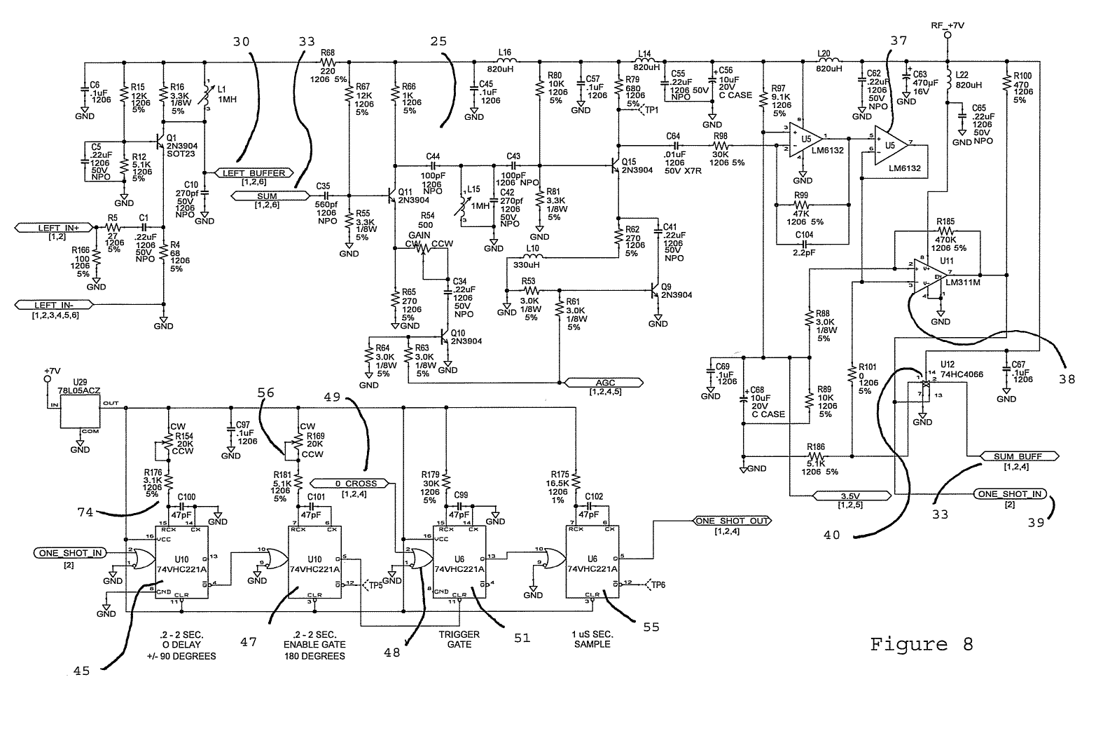

As illustrated in FIG. 7, a single first coaxial cable 24 may connect the first antenna 14 to a left receiver channel 25, a single second coaxial cable 26 may connect the second antenna 15 to a right receiver channel 27 and a single third coaxial cable 28 may connect the third antenna 16 to a middle receiver channel 29. It may be noted that the three antennas 14-16 are not interconnected in this arrangement. The three radio receiver channels 25,27,29 are tuned to a selected channel frequency. For instance, a crystal filter with a 775 Hz stop band with 60 dB of attenuation may be employed to provide approximately 300 channels in the same frequency spectrum. While eight channels are believed to be adequate, the number of channels could be expanded dramatically. The narrow bandwidth provides some immunity to spurious signals and make a modulated carrier ‘key tone’ unnecessary. Instead a continuous wave signal may be employed, thereby simplifying the transmitter and receiver design and providing narrower channel spacing as described previously

As illustrated in FIGS. 7, 8, 10 and 12, the left receiver 25 has a buffer amplifier 30 connected to a sum/difference amplifier 31, and the right receiver 27 has a buffer amplifier 32 connected to the sum/difference amplifier 31. The sum/difference amplifier 31 has two outputs, one 33 is a sum of the left 30 and right 32 signals and the other 34 is the difference between the amplitudes of the left 30 and right 32 signals. Advantageously, the sum/difference amplifier 31 is not tuned, nor is it temperature sensitive and can be balanced by means of a trimming potentiometer 34. In this manner, drift in the resonant frequency of the antennas 14, 15 or in the impedance of the cables 24, 26 will not affect the steering of the equipment caddy 18.

The difference in signal strength from the transmitter 80 dictates the cart's steering. The output of this switching circuit develops a DC signal with polarity and amplitude proportional to the difference in amplitude between left and right signals and is used to control Left/Right steering of the cart. If the user-carried transmitter 80 is positioned in front of the cart, in range, and toward the left, the difference of the signal strength received by each side, right and left, dictates how far to the left the cart will turn from center. The difference amplifier circuit 32, 34 is used to make this calculation.

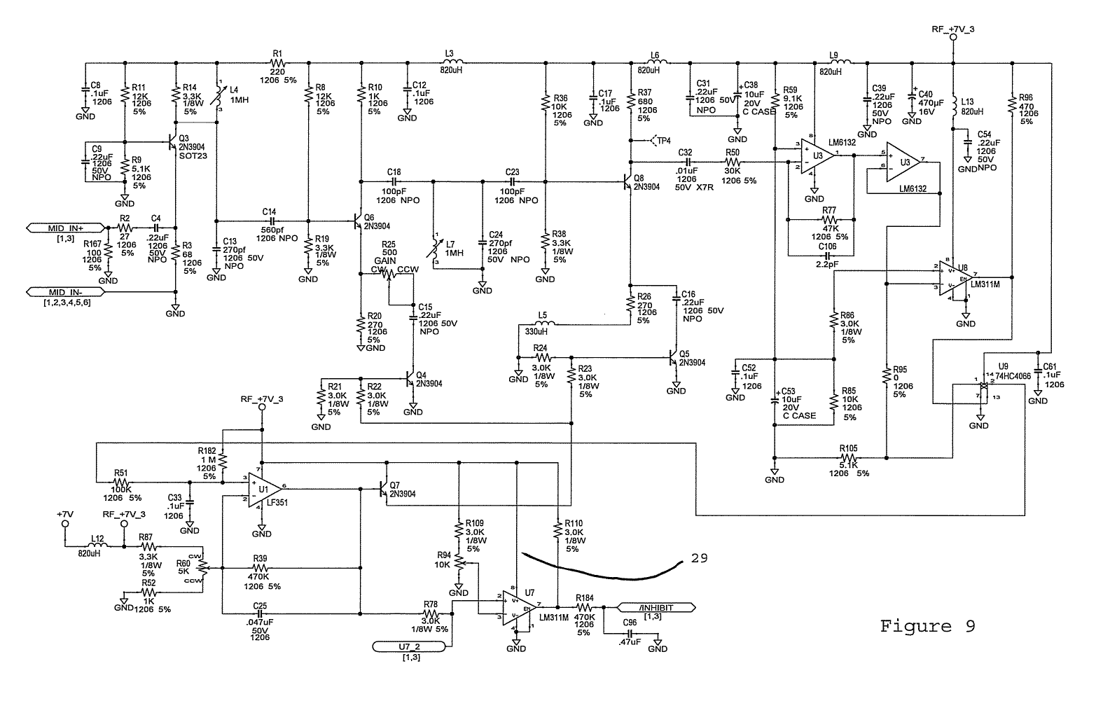

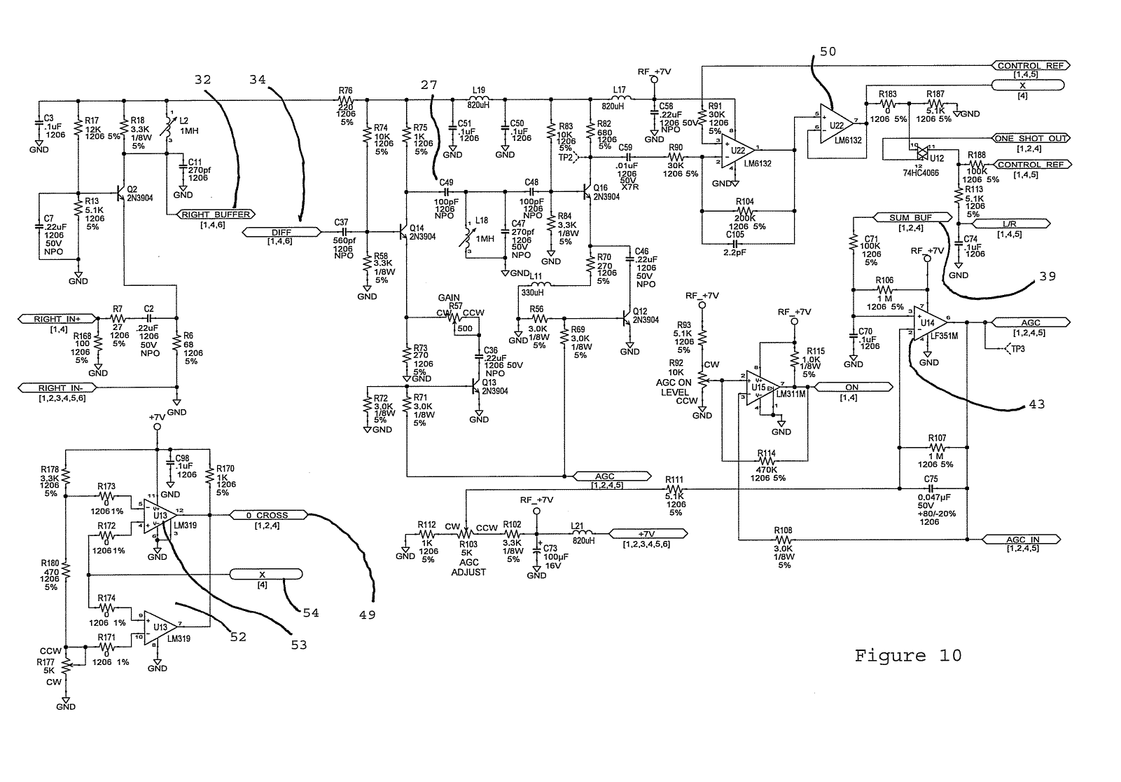

The sum amplifier circuit 30, 32 calculates the signal strength received from the transmitter 80 to determine how much to speed up or slow down the forward or backward motion of the cart. As indicated in FIG. 8, the sum output 34 is connected to additional stages of amplification and develops an automatic gain control signal 35, which is used by both the left and right receivers 25, 27 to regulate gain. The automatic gain control signal 35 is proportional to the distance of the user to the left and right antennas 14, 15 and is used to regulate speed and forward or reverse movement of the cart. The sum output is also used to synchronize a switching circuit, which samples the difference signal at the carrier rate. The carrier rate refers to the different frequency used by each channel, since, as previously indicated, different channels may be assigned to various carts to allow more than one cart to be used at the same time on each golf hole.

As illustrated in FIGS. 7,10 and 11, the right channel 27 and a signal processor 36 may correct for phase shift by first synchronizing with the sum signal, and then waiting for the difference signal's zero crossing to enable the sampling of the amplitude of the difference signal. Thus, even though the sum and difference signals may drift in phase due to normal variation in filter & tuned circuit's phase shift, the steering signal developed is not affected.

As indicated in FIG. 8, a sum output signal from a comparator 37 is fed into the (−) input of another comparator 38 whose other input (+) is at amplifier ‘zero’ level, approximately 3.5 VDC. When the ‘sum’ signal 37 rises above the ‘zero’ level of 3.5 Volts, the comparator 38 output switches negative and goes to ground. The comparator 38 output is a square wave whose negative-going edge is synchronized with the ‘sum’ signal 33 positive half of the waveform. This synchronized signal 39 is used to ‘gate’ an analog switch 40 that samples only the positive portion of the sum signal 33

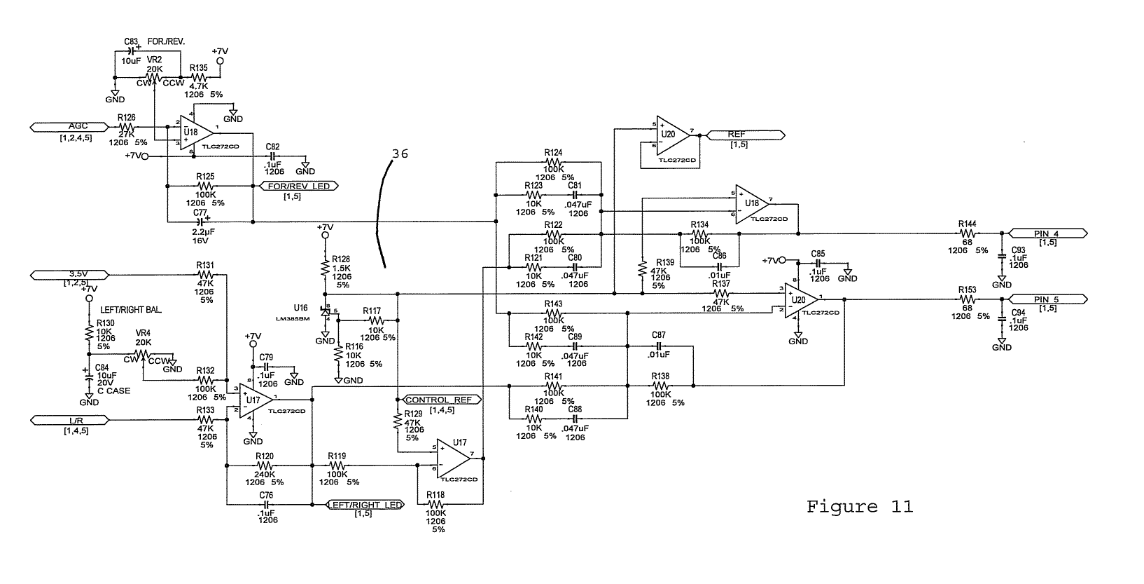

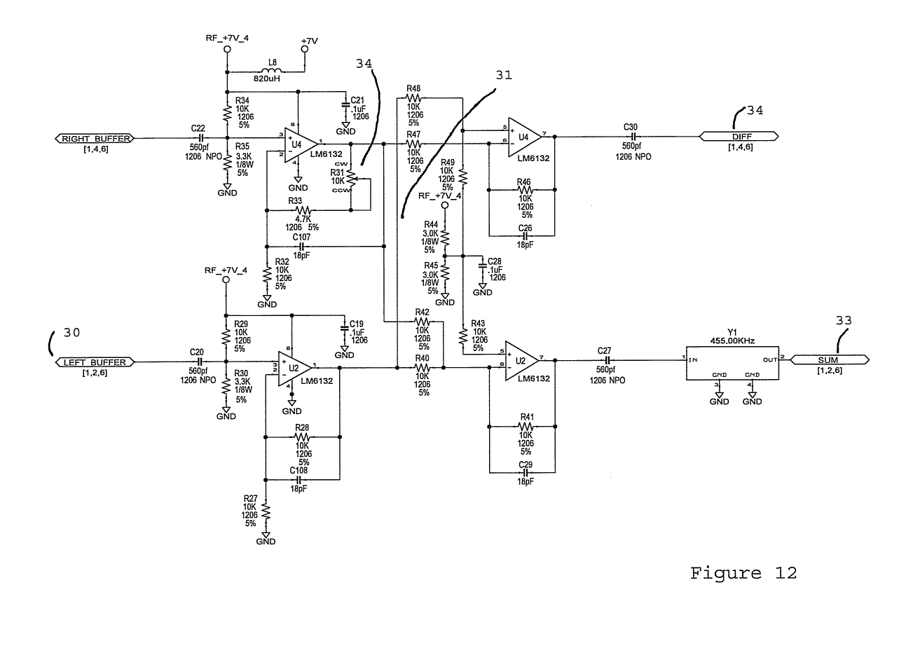

As indicated in FIG. 10, the sum signal 33 is filtered by 100K resistor 41 and a 0.1 uf capacitor 42, then amplified by comparator 43 to provide a DC level corresponding to the amplitude of the ‘sum’ signal 33.

Referring to FIG. 8, the synchronized signal 39 goes to the ‘one-shot’ circuit 44. The first one-shot 45 provides a delayed timing pulse synchronized with the sum signal 33 and adjustable by a variable resistor 46 to allow adjustment for phase shift in the amplifiers. The output of the first one shot 45 is connected to the trigger input of a second adjustable one shot 47. The output of this second one shot 47 is an enable gate 48 that is active for ½ of the period of the channel frequency and centered around the ‘zero crossing’ point 49 provided by the difference signal's output buffer 50 illustrated in FIG. 10.

Referring to FIG. 8, the enable gate 48, is connected to the ‘clear’ input of a third one shot 51 that acts as a trigger gate. The trigger 51 is connected to the zero-crossing detector subcircuit 52 shown in FIG. 10. The zero-crossing circuit 52 may be provided with a window comparator 53 that is connected to the output 54 of the difference signal amplifier 50. The output 54 is a positive pulse when the difference signal actually passes through zero. As previously indicated, the output 49 of the zero crossing detector 52 is connected to the trigger input of the trigger gate 51 shown in FIG. 8. The zero cross detector 52 delivers an output 49 both on the rising edge and the falling edge of the difference signal 34 whenever the signal 34 passes through the zero level. Only one the two pulses will be concurrent with the enable gate. When this occurs, the trigger gate 51 outputs a pulse that triggers the fourth one shot 55 to become a sample gate that is centered about the peak of the difference signal 34. Because these one-shots are triggered on the zero crossing of the difference signal, the sample gate 55 will remain centered about the peak of the difference signal 34 even if there is phase drift between the sum 33 and difference 34 signals up to +/−90 of phase shift. The sum signal 33 permits the enable gate 47, that is delayed by an adjustable delay 56, to be centered about the difference signal 34. This insures that there is no drift in steering signal level even though the phase relation between the sum and difference signals changes. This eliminates changes in steering due to the variation of phase shift resulting from the combined drift in the tuned circuits of the antenna, filter and amplifiers. Although low drift components are used in these tuned circuits, it is impossible to achieve zero drift with temperature. Thus, without this novel circuit, the steering ability would vary greatly with variation of ambient temperature.

Channel Antenna and Amplifier. Prior art utilized two antennas and turned the unit on when the golfer with the hand held unit was located in a location area determined by a predetermined distance from each antenna. The problem is that this condition is satisfied in two distinct locations, one in front of the cart and the other in back of the cart. If the transmitter was turned on with the golfer in back of the cart, the cart would abruptly swing around to face the golfer and in doing so could possibly hit someone or something Our unit has a third antenna located in the rear of the cart that senses if the golfer is behind the cart and inhibits the control from turning on. This antenna also provides a shut-off if the cart gets too close to the golfer for any reason. This can occur if the hand-held unit is tilted for example, if the golfer bends over to pick up something on the ground. The hand held unit also has a ‘tilt’ sensor that shuts off the cart if the hand held unit is tilted more than 45 degrees from vertical in any direction for more than 1 second. This circuit is disabled though if the cart is moving in reverse. This allows the cart to be moved backward with the person guiding the cart to be closer than normal to the cart.

The automatic gain control/speed signal and the Left/Right steering signal may be added together to produce a speed/direction signal for the two cart motors 11. The cart steers by controlling the direction and speed of each motor 11 separately. This signal may be referenced to 2.5VDC, which is zero speed or stopped. If the voltage is above 2.5V, the motor will drive in one direction; if the voltage is below 2.5V, the motor will drive in the opposite direction at a speed proportional to the difference between +2.5V and the signal. For example, +5VDC could be full speed in one direction, and 0 VDC could be full speed in the opposite direction. If the automatic gain control/speed signal is calling for backward movement, a DC signal to operate a backup beeper may be activated.

The third channel antenna 12 and receiver 9 channel may be used to prevent the cart from turning on when the user is positioned behind the cart. The turn-on may be controlled by monitoring the left and right motor speed signals so that the cart turns on when the user is located approximately 5 feet from both the left and right antennas. This could be the normal distance that the cart follows the user, and the motors are practically stopped. However, this condition is satisfied at two possible locations, one when the user is in front of the cart, and the other when the user is in back. If the cart were turned on with the user in back of the cart, it would spin 180 degrees fairly rapidly. This would occur when the motors start to move after turn on, as they will move in the opposite direction if the user is behind the cart. If this were allowed to occur, it could cause injury to someone in the vicinity of the cart. To prevent this, the third antenna 12 is mounted at the rear of the cart, and its associated amplifier develops a signal proportional to the distance to the user. If this signal is above a certain amplitude, indicating that the user or another user is too close to the rear of the cart, the cart will not turn on, or if already on will shutoff. This is an important safety feature preventing the cart spin-around problem just described or allowing another user interfering with the proper directional control of the cart.

The rear antenna 16 and mid channel receiver 29 also provide a shut-off if the cart gets too close to the golfer for any reason. This can occur if the hand-held unit 17 is tilted, for example, if the golfer bends over to pick up something on the ground. The hand held unit 17 also has a ‘tilt’ sensor that shuts off the cart 18 if the hand held unit 17 is tilted more than 45 degrees from vertical in any direction for more than 1 second. This circuit is disabled if the cart is moving in reverse. This allows the cart to be moved backward with the person guiding the cart to be closer than normal to the cart.

When all three antenna signals are at the appropriate amplitude indicating the user is directly in front of the cart at the prescribed distance, the receiver module 9 will activate the power module 6. The motors 12, 13 will power up and brakes (not shown) will be released with only a small amount (if any) of cart movement. The cart 18 will not turn on if the user is either too close or too far away (otherwise, the cart would move too rapidly). An LED indicator 57 on the receiver 8 indicates that the power module 6 is activated and the cart 18 ready to move. This signal is latched and remains on unless the signal from the user is lost or goes out of range limits for any reason. If the cart 18 is prevented from keeping up with user movement, (such as slipping wheels) it will shut off when the user gets too far away and the automatic gain control/speed signal goes beyond a preset limit.

The power module 6 controls motor speed and direction in response to the two speed/direction signals from the receiver 9. A motor ON signal from the receiver module 9 turns on the high power supervisory relays 7 that connect the batteries to the FET transistors that rapidly switch the DC power to the motors 11 to control the speed of the motors. This motor ON signal also applies power to the brake circuit releasing the motor brakes. If the receiver module 9 turns off the motor ON signal, (e.g., the User switches the transmitter off or there is loss of signal for any reason) the batteries are disconnected from the motor drive circuit and brakes are applied immediately.

The motor's speed and direction is controlled by comparing the speed/direction signal from the receiver module 9 with an internally generated voltage ramp signal resulting in a digital output pulse whose duration is proportional to the absolute difference between the speed signal and the 2.5V reference level. This pulse is applied to the gates of the appropriate (forward or backward bank of three) power FET transistors to apply full battery power to the motor 11 for the duration of the pulse. The more speed that is called for results in a longer time that power is switched on the motor 11. At full speed, the pulse width approaches the pulse repetition time so that power is on continuously, resulting in full motor speed. Conversely, as the control calls for less speed, the power is applied for a shorter time interval until the pulse width is practically zero, causing the motor to stop.

If the motor is coasting, it acts as a voltage generator. This motor-generated voltage is applied as negative feedback to the control circuit 8, so that the control circuit 8 can apply reverse polarity to dynamically brake the motors. This arrangement is needed when the cart is going down a hill or stopping on a hill to prevent it from running into the user or coasting backward. The power module also has a DC to DC switching power supply to generate a higher ‘boost’ voltage (approx 36 VDC) to allow full turn-on of the FET transistor connected to the +12V battery. A protection circuit shuts off the supervisory relays 7 if this circuit fails, thereby preventing burn-up of the power FET transistors due to insufficient gate drive.

Finally, each of the power FET transistors (12 in all) has a fusible link of #30 AWG wire that will open the circuit in the event of a power FET transistor shorting out. This is to prevent circuit board burn-up in the event of a component failure.

1. A process for autonomous control of steering, speed, forward and reverse movement of a motor vehicle comprising the steps of:
a. transmitting a signal from a device carried by an ambulatory user;
b. receiving said signal with three signal-receiving antennae on the motor vehicle;
c. generating first, second and third sub-signals with a three-channel receiver connected to said three antennae;
d. generating sum and difference outputs with the first and second sub-signals;
e. affecting the steering with said difference output;
f. affecting the speed, forward and reverse control with the sum output;
g. generating a distance-to-user output from the third sub-signal; and
h. limiting the proximity of the motor vehicle to the user with the distance-to-user output.

2. The process according to claim 1 wherein the step of affecting the steering with the difference output comprises developing a steering signal with polarity and amplitude proportional to the difference in amplitude between the first and second subsignals

3. The process according to claim 2 wherein the step of affecting the speed, forward and reverse movement with the sum output comprises generating an automatic gain control signal from the sum output.

4. The process according to claim 3, and further comprising the step of providing a combined automatic gain control and steering signal

5. The process according to claim 4, and further comprising the step of providing the motor vehicle with two motors.

6. The process according to claim 5, and further comprising the steps of referencing the combined automatic gain control and steering signal to a selected voltage and producing separate drive/steering signals for each of the two motors.

7. The process according to claim 6, wherein the drive/steering signal runs the motor to which said signal is applied at a speed proportional to the difference between the selected voltage and the combined automatic gain control and steering signal.

8. The process according to claim 6, wherein the drive/steering signal runs the motor to which said signal is applied in a direction determined by whether the selected voltage is greater or less than the combined automatic gain control and steering signal.

9. The process according to claim 1, wherein the step of generating a distance-to-user output from the third sub-signal comprises developing a distance-to-user output which is proportional in amplitude to the distance between the third antenna and the user.

10. The process according to claim 9, and further comprising the step of generating a motor activation signal if the distance-to-user signal is below a selected amplitude.

11. The process according to claim 10, and further comprising the steps of providing a brake on the motor vehicle and releasing said brake in response to the motor activation signal.

12. The process according to claim 11, and further comprising the step of applying the brake when the motor vehicle is going down a hill.

13. Apparatus for autonomous control of steering, speed, forward and reverse movement of a motor vehicle comprising:
a. a signal-generating transmitter adapted to be carried by an ambulatory user;
b. three signal-receiving antennae located in a triangular pattern on the motor vehicle;
c. a three-channel receiver connected to said three antennae, said receiver generating first, second and third sub-signals;
d. sum and difference amplifier circuits receiving the first and second sub-signals and generating sum and difference outputs;
e. means for affecting the steering with said difference output;
f. means for affecting the speed, forward and reverse movement with the sum output
g. means for generating a distance-to-user output from the third sub-signal; and
h. means for limiting the proximity of the motor vehicle to the user with the distance-to-user output.
